(19) United States
(12) Patent Application Publication
(10) Pub. No.: US 2021/0299488 A1
(43) Pub. Date: Sep. 30, 2021

(54) DUAL MODE PROTECTIVE FACE MASK

(71) Applicant: OP-D-OP, INC., Roseville, CA (US)

(72) Inventor: Timothy J. Landis, Loomis, CA (US)

(73) Assignee: OP-D-OP, INC., Roseville, CA (US)

(21) Appl. No.: 17/213,737

(22) Filed: Mar. 26, 2021

Related U.S. Application Data
(60) Provisional application No. 63/001,369, filed on Mar. 29, 2020.

(51) Int. Cl. A62B 23/02; A41D 13/11

(52) U.S. Cl. CPC A62B 23/025; A41D 13/1169

(57) ABSTRACT

A dual mode face mask wherein in a first mode the mask can be used normally and in a second mode the mask can be sealed against the user's skin.

### CROSS-REFERENCE TO RELATED APPLICATIONS

This application claims priority to, and the benefit of, U.S. provisional patent application Ser. No. 63/001,369 filed on Mar. 29, 2020, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to protective face mask, and more particularly to face masks having a seal around the user's face.

### 2. Background Discussion

A problem with face masks is that they are not sealed against the user's face. In normal use, when the user exhales the exhaled gases vent around the edges of the mask. If someone sneezes or coughs, viruses can traverse the edges of the mask thereby exposing the user to the virus.

### BRIEF SUMMARY

An aspect of the technology presented herein is to provide a dual mode face mask wherein in a first mode the mask can be used normally and in a second mode the mask can be sealed against the user's skin. In one embodiment, the mask has a peripheral adhesive band on its back (interior) side that faces the user. A separator is provided with a surface on one side that covers the peripheral adhesive band. The surface on the other side of the separator may be covered with a backing material comprising a cloth fabric or other material normally found on a mask. In a first mode, the mask is worn normally. In a second mode, the user can peel away the separator, thereby exposing the adhesive band. The user can then press this “sticky” mask onto his or her skin. This second mode of use is intended to seal the mask to the user's face when the user encounters a high danger situation such as exposure to a virus.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a front (exterior) view of a surgical type dual mode protective face mask according to an embodiment of the technology of this disclosure.

FIG. 2 is cross-section view of the face mask shown in FIG. 1 taken through lines 2-2.

FIG. 3 is an enlargement of a portion of the cross-section shown in FIG. 2.

FIG. 4 is a back (interior) view of the face mask shown in FIG. 1 through FIG. 3.

FIG. 5 is an exploded view as seen from the rear of the face mask of FIG. 1 through FIG. 4.

FIG. 6 is a front (exterior) view of a conical type dual mode protective face mask according to an embodiment of the technology of this disclosure.

FIG. 7 is a rear (interior) view of the face mask of FIG. 7.

FIG. 8 is an exploded view of the face mask of FIG. 6 and FIG. 7.

### DETAILED DESCRIPTION

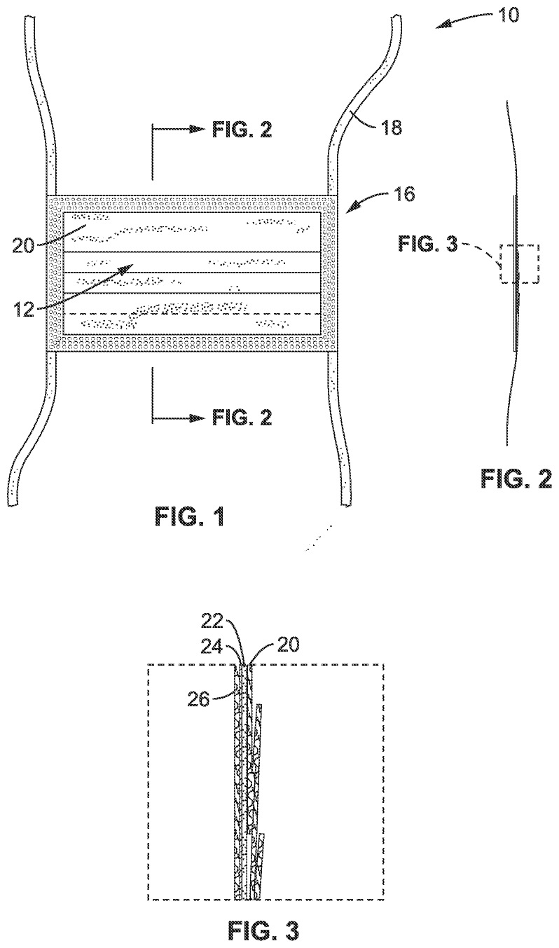

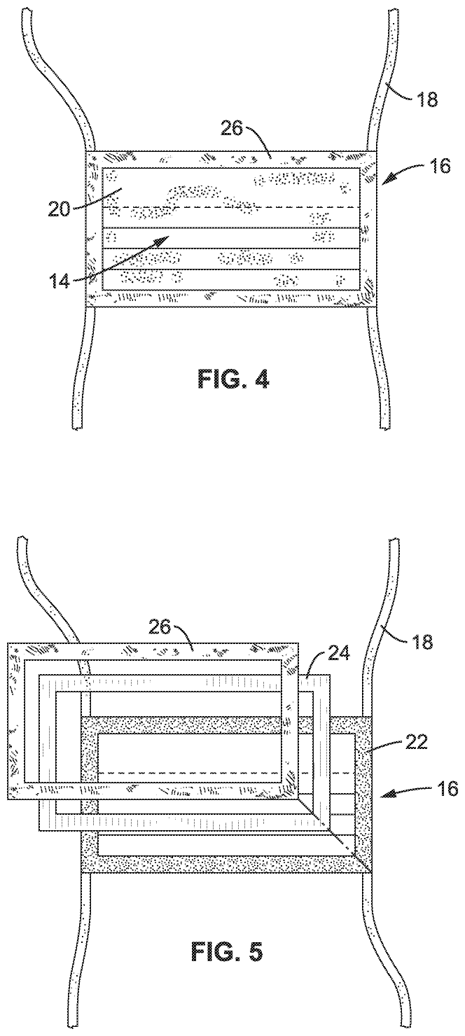

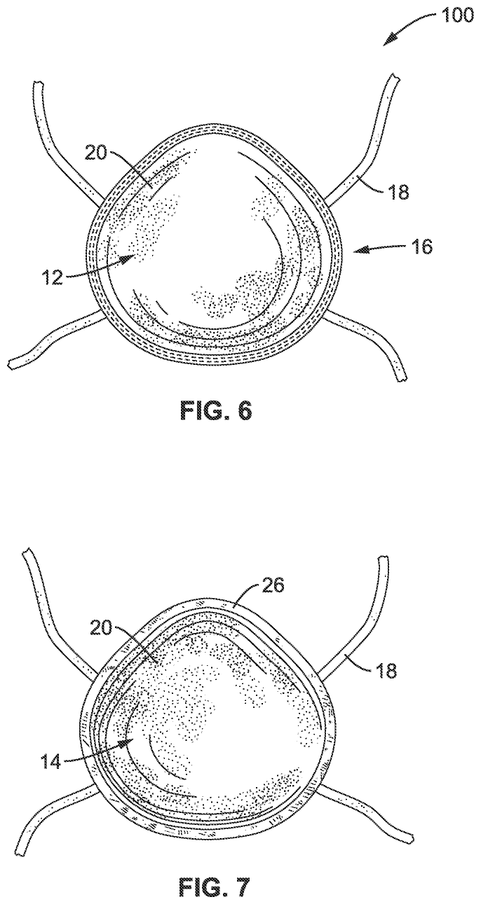

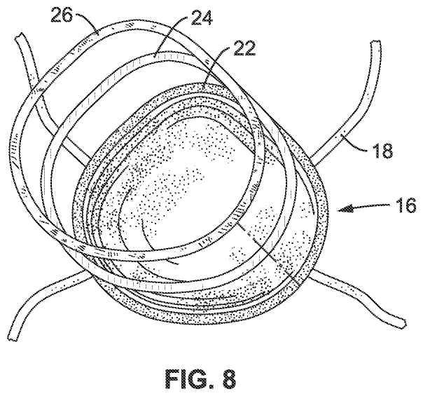

FIG. 1 through FIG. 8 generally illustrate embodiments of a dual mode protective face mask according the technology presented herein. FIG. 1 through FIG. 5 illustrate an embodiment of dual mode protective face mask 10 having a surgical face mask format. FIG. 6 through FIG. 8 illustrate an embodiment of a dual mode protective face mask 100 having a conical format commonly found with N95 or N99 face masks.

Referring first to the embodiment of FIG. 1 through FIG. 5, the face mask 10 has a front or exterior side 12 that faces away from the user when worn and a rear or interior side 14 that faces toward the user's face when worn. Each of the exterior and interior sides of the mask has a peripheral border or periphery 16 that may be reinforced such that, for example, one or more straps 18 or other means can be attached to periphery of the filter 20 and configured to hold at least a portion of the interior side of the mask against at least a portion of the user's face when in use. Depending on the type of filter material used, the filter material itself may be of sufficient strength that the straps can be attached directly to the material. Also, it will be appreciated that as used herein the term “strap” can mean an elongated strap such as found on surgical masks, an elastic strap such as found on an N95 or N99 “cone” type mask, or other means for holding the mask in place.

An adhesive material 22 is placed around at least a portion of the periphery of the interior side of the mask (e.g., along the peripheral border or partially interior of the peripheral edge). Preferably the adhesive material is applied as a band that extends around the entire peripheral edge rather than in segments. The type of adhesive material is preferably the type used with medical electrode pads, such as EKG electrode pads or the like, which is a FDA approved adhesive for contacting human skin.

A separator 24 is provided to cover the band of adhesive material. The separator is preferably shaped to match the contour of the periphery of the mask and need only cover the band of adhesive. Accordingly, the separator does not obstruct the filter. The separator is preferably sized to cover the entire band of adhesive material so that the adhesive material is not exposed to the elements or contact the user's skin while in normal use of the mask.

The separator preferably comprises a material that adheres to the band of adhesive material with less strength than the adhesive material adheres to the filter. Non-limiting examples of material that can be used for the separator include waxy-type paper or the type of peel away pad that covers the adhesive on EKG electrodes. As a result, the separator can be peeled away from the band of adhesive material and removed from the mask without removing the adhesive material from the mask. The thickness of the separator material need only be sufficient to allow the separator material to be removed without substantial tearing or other condition that would make removal difficult. The separator may also exhibit some degree of rigidity or moldability if desired to allow the separator to be shaped. For example, a wire or the like could be embedded in the separator similar to bag ties or pipe cleaners.

One or more sections of backing material 26 are preferably, but optionally, attached to the periphery of the separator that would face the user. If included, the backing material preferably comprises the same type of material that would contact the user's face in a conventional mask. Other materials could be used as well. At least a portion of the one or more sections of said backing material is configured to rest against a least a portion of the user's face for comfort. It will be appreciated that since the backing material is attached to the periphery of the separator, the opening to the filter is not obstructed by the backing material. It will also be appreciated that the separator could be formed with an interior facing surface that provides comfort to the user without use of a backing material.

When the separator is removed, the band of adhesive material is exposed and at least a portion of the adhesive material can be pressed against the user's skin to seal at least a portion of, and preferably the entire, periphery of the interior side of the mask against the user's skin. In this way, the periphery of the mask can be sealed against the user's skin to prevent substance ingress around the periphery of the mask.

Therefore, this mask has two modes of use. The first mode of use is that the user can simply wear the mask like any other mask. But, when the user encounters a high danger situation, such as when near a coughing person, the user can back up to a safe distance and peel away the separator thereby exposing the band of adhesive material, and then press this “sticky” mask onto his or her skin. This second mode of use is intended to seal the mask to the user's face when the user encounters a high danger situation such as exposure to a virus. It will be harder for the user to breath with the mask sealed in this manner, especially for N95 or N99 masks or respirators, but the protection should be superior to that of a standard mask for sufficient time to change dressings, or change IV fluids with a sick patient, or even protect against exposure from a coughing or sneezing person who the user encounters on public transportation, in a grocery store or in some other public area.

It will be appreciated that the embodiment of a dual mode protective face mask 100 illustrated in FIG. 6 through FIG. 8 is configured and functions as described above but is in a conical face mask format. Accordingly, like reference numbers denote like parts.

It will also be appreciated that this mask can be configured as a surgical mask, as a respirator mask, as a droplet blocking mask, as a virus blocking mask, or as any other type of protective mask where peripheral sealing would provide additional protection. The particular filter material can be chosen to reduce passage of various substances as desired.

In all of the embodiments, the protective face mask employs a conventional filter sufficient to reduce particular substances in the air from passing through the filter. For example, the filter may be a material that reduces passage of droplets, viruses, microbes, bacterial and other substances that could be toxic or otherwise create a danger to a user from exposure. All embodiments further comprise features that allow the face mask be used in a first, conventional mode, and a second, sealed mode.

From the description herein, it will be appreciated that the present disclosure encompasses multiple implementations of the technology which include, but are not limited to, the following:

A protective face mask, comprising: (a) a filter comprising a material sufficient to reduce certain airborne substances from passing through the filter; (b) the mask having an exterior side and an interior side, said interior side having a periphery around the filter; (c) an adhesive material around a substantial portion of the periphery of the interior side of the mask; (d) a separator attached to the adhesive material and configured to be peeled away from the adhesive material and removed from the mask; (e) wherein when the separator is removed, the adhesive material is exposed; and (f) wherein when the adhesive material is exposed, the adhesive material can be pressed against at least a portion of the user's face to seal at least a portion of the periphery of the interior side of the mask against said pressed against portion of the user's face.

A protective face mask, comprising: (a) means for holding the mask in place adjacent a user's face; (b) a filter comprising a material sufficient to reduce a presence of certain substances from passing through the filter; (c) the mask having an exterior side and an interior side, said interior side having a periphery around the filter; (d) an adhesive material around a substantial portion of the periphery of the interior side of the mask; (e) a separator having a periphery attached to the adhesive material and configured to be peeled away from the adhesive material and removed from the mask; (f) wherein said separator does not obstruct said filter; (g) a backing material attached to the periphery of the separator and configured to rest against a least a portion of the user's face; (h) wherein when the separator is removed, the adhesive material is exposed; and (i) wherein when the adhesive material is exposed, the adhesive material can be pressed against at least a portion of the user's face to seal at least a portion of the periphery of the interior side of the mask against said pressed against portion of the user's face.

A protective face mask, comprising: (a) a filter comprising a material sufficient to reduce a presence of certain substances in air from passing through the filter; (b) the mask having an exterior side and an interior side, said interior side having a periphery around the filter; (c) one or more straps attached to periphery of the mask and configured to hold at least a portion of the interior side of the mask against at least a portion of a user's face; (d) an adhesive material around at least a portion of the periphery of the interior side of the mask; (e) a separator attached to the adhesive material, said separator having a cutout that defines a periphery of the separator and provides an opening to said filter, and wherein at least a portion of the periphery of the separator is attached to the adhesive material on the interior side of the mask; (f) one or more sections of backing material attached to the periphery of the separator, wherein at least a portion of said one or more sections of said backing material is configured to rest against a least a portion of the user's face; (g) wherein said separator is configured to be peeled away from said adhesive material and removed from the mask; (h) wherein when said separator is removed, said adhesive material is exposed; and (i) wherein when said adhesive material is exposed, at least a portion of said adhesive material can be pressed against at least a portion of the user's face to seal at least a portion of the periphery of the interior side of the mask against said portion of the user's face.

The protective face mask of any preceding implementation, wherein the adhesive material comprises a band of adhesive material.

The protective face mask of any preceding implementation, wherein said face mask is configured a surgical mask.

The protective face mask of any preceding implementation, wherein said face mask is configured as a respirator mask.

The protective face mask of any preceding implementation, wherein said face mask is configured as a droplet blocking mask.

The protective face mask of any preceding implementation, wherein said face mask is configured as a virus blocking mask.

The protective face mask of any preceding implementation, wherein said filter comprises a material sufficient to reduce passage of a virus.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A protective face mask, comprising:
(a) a filter comprising a material sufficient to reduce certain airborne substances from passing through the filter;
(b) the mask having an exterior side and an interior side, said interior side having a periphery around the filter;
(c) an adhesive material around a substantial portion of the periphery of the interior side of the mask;
(d) a separator attached to the adhesive material and configured to be peeled away from the adhesive material and removed from the mask;
(e) wherein when the separator is removed, the adhesive material is exposed; and
(f) wherein when the adhesive material is exposed, the adhesive material can be pressed against at least a portion of the user's face to seal at least a portion of the periphery of the interior side of the mask against said pressed against portion of the user's face.

2. The protective face mask of claim 1, wherein the adhesive material comprises a band of adhesive material.

3. The protective face mask of claim 1, wherein said face mask is configured a surgical mask.

4. The protective face mask of claim 1, wherein said face mask is configured as a respirator mask.

5. The protective face mask of claim 1, wherein said face mask is configured as a droplet blocking mask.

6. The protective face mask of claim 1, wherein said face mask is configured as a virus blocking mask.

7. The protective face mask of claim 1, wherein said filter comprises a material sufficient to reduce passage of a virus.

8. A protective face mask, comprising:
(a) means for holding the mask in place adjacent a user's face;
(b) a filter comprising a material sufficient to reduce a presence of certain substances from passing through the filter;
(c) the mask having an exterior side and an interior side, said interior side having a periphery around the filter;
(d) an adhesive material around a substantial portion of the periphery of the interior side of the mask;
(e) a separator having a periphery attached to the adhesive material and configured to be peeled away from the adhesive material and removed from the mask;
(f) wherein said separator does not obstruct said filter;
(g) a backing material attached to the periphery of the separator and configured to rest against a least a portion of the user's face;
(h) wherein when the separator is removed, the adhesive material is exposed; and
(i) wherein when the adhesive material is exposed, the adhesive material can be pressed against at least a portion of the user's face to seal at least a portion of the periphery of the interior side of the mask against said pressed against portion of the user's face.

9. The protective face mask of claim 8, wherein the adhesive material comprises a band of adhesive material.

10. The protective face mask of claim 8, wherein said face mask is configured a surgical mask.

11. The protective face mask of claim 8, wherein said face mask is configured as a respirator mask.

12. The protective face mask of claim 8, wherein said face mask is configured as a droplet blocking mask.

13. The protective face mask of claim 8, wherein said face mask is configured as a virus blocking mask.

14. The protective face mask of claim 8, wherein said filter comprises a material sufficient to reduce passage of a virus.

15. A protective face mask, comprising:
(a) a filter comprising a material sufficient to reduce a presence of certain substances in air from passing through the filter;
(b) the mask having an exterior side and an interior side, said interior side having a periphery around the filter;
(c) one or more straps attached to periphery of the mask and configured to hold at least a portion of the interior side of the mask against at least a portion of a user's face;
(d) an adhesive material around at least a portion of the periphery of the interior side of the mask;
(e) a separator attached to the adhesive material, said separator having a cutout that defines a periphery of the separator and provides an opening to said filter, and wherein at least a portion of the periphery of the separator is attached to the adhesive material on the interior side of the mask;
(f) one or more sections of backing material attached to the periphery of the separator, wherein at least a portion of said one or more sections of said backing material is configured to rest against a least a portion of the user's face;
(g) wherein said separator is configured to be peeled away from said adhesive material and removed from the mask;
(h) wherein when said separator is removed, said adhesive material is exposed; and
(i) wherein when said adhesive material is exposed, at least a portion of said adhesive material can be pressed against at least a portion of the user's face to seal at least a portion of the periphery of the interior side of the mask against said portion of the user's face.

16. The protective face mask of claim 15, wherein the adhesive material comprises a band of adhesive material.

17. The protective face mask of claim 15, wherein said face mask is configured a surgical mask.

18. The protective face mask of claim 15, wherein said face mask is configured as a respirator mask.

19. The protective face mask of claim 15, wherein said face mask is configured as a droplet blocking mask.

20. The protective face mask of claim 15, wherein said face mask is configured as a virus blocking mask.

21. The protective face mask of claim 15, wherein said filter comprises a material sufficient to reduce passage of a virus.
